(19) United States
(12) Patent Application Publication
(10) Pub. No.: US 2006/0287021 A1
(43) Pub. Date: Dec. 21, 2006

(54) A METHOD AND MEANS FOR ENHANCING A PLAYING EXPERIENCE OF A PLAYER OF A VIDEO GAME

(76) Inventor: Frederick Michael Blum, Los Angeles, CA (US)

Correspondence Address: LAHIVE & COCKFIELD, 28 STATE STREET, BOSTON, MA, 02109, US

(21) Appl. No.: 11/160,248

(22) Filed: Jun. 15, 2005

(51) Int. Cl. A63F 13/00

(52) U.S. Cl. 463/1

(57) ABSTRACT

A method of enhancing a playing experience of a player of a video game includes the step of executing game code to display a first set of content to a player. In addition to the first set of content, a second set of content is displayed to the player upon execution of a trigger, the second set of content comprising metadata associated with the game code.

### FIELD OF THE INVENTION

The present invention relates to a method and apparatus for enhancing a playing experience and, in particular, to a method and apparatus for enhancing a playing experience of a player of a video game.

### BACKGROUND OF THE INVENTION

Conventionally, media providers offer users the option of viewing information about the media. For digital video disc (DVD) media, this metadata typically includes behind-the-scenes data, interviews with actors or directors, or additional footage. For television media, this information may include descriptions of the television show, listings of the actors in the show, rating information, or information about the channel airing the show. These options are generally made accessible to the user via a system of menus. The ability to view this information typically enhances the entertainment level of the user.

In some conventional computer environments, users may select a particular menu item to receive information about the environment. These environments typically provide users with instructions for operating a computer program, as in technical support or help desk environments. These instructions do not typically enhance a level of entertainment for the user. Furthermore, this information typically requires that the user cease operation of the program to review the information and carry out any instructions provided. Conventionally, information provided in a computer program to a user in these environments interrupts the operation of the program to provide technical details regarding proper operation of the program.

In environments where the underlying media is less interactive, however, viewing background information associated with the media is not typically offered. For example, in a gaming environment where a user plays a game by providing input to executing game code, conventional environments do not offer the user to play the game and substantially simultaneously receive background information about the game. In many of these environments, it would be desirable to view information without ceasing operation of the game, and having the option of viewing this information would increase a level of entertainment experienced by the user. A method for providing users of entertainment media with the ability to view information about the media while interacting with the media is desirable.

### BRIEF SUMMARY OF THE INVENTION

The present invention relates to a method of and means for enhancing a playing experience of a player of a video game. The invention enables a media provider to enhance a level of entertainment experienced by a player by offering players the option of viewing information associated with a game without interrupting player interaction with the game.

In one aspect, the invention relates to a method of enhancing a playing experience of a player of a video game. Game code executes to display a first set of content to a player. In addition to the first set of content, upon execution of a trigger, a second set of content is displayed to the player. This second set of content comprises metadata associated with the game code.

In one embodiment, the metadata comprises facts about the video game. In another embodiment, the metadata comprises facts about development of the video game.

In another aspect, the invention relates to an apparatus for enhancing a playing experience of a player of a video game. The apparatus includes system memory and a processor of the system. The system memory stores game code and sets of content. The processor of the system is in communication with the system memory and executes the game code to display to a player a first set of content and, upon execution of a trigger, a second set of content, the second set of content comprising metadata associated with the game code.

### BRIEF DESCRIPTION OF THE DRAWINGS

These and other aspects of this invention will be readily apparent from the detailed description below and the appended drawings, which are meant to illustrate and not to limit the invention, and in which:

FIG. 1 is a block diagram depicting one embodiment of a gaming environment in which the present invention may be employed;

FIG. 2A and 2B are block diagrams depicting embodiments of a computer useful in connection with the present invention;

FIG. 3 is a flow diagram depicting one embodiment of the steps taken to enhance a playing experience of a player of a video game;

FIG. 4 is a screen shot depicting one embodiment of a first set of content displayed with a second set of content;

FIG. 5 is a screen shot depicting one embodiment of a second set of content comprising facts about the video game;

FIG. 6 is a screen shot depicting one embodiment of a second set of content providing the user with a suggestion relating to game play;

FIG. 7 is a screen shot depicting an embodiment of a second set of content comprising information about a video game developer;

FIG. 8 is a screen shot depicting one embodiment of a second set of content comprising information describing an influence on the design;

FIG. 9 is a screen shot depicting one embodiment of a second set of content comprising information about development of the video game; and

FIG. 10 is a screen shot depicting a second embodiment of a second set of content comprising information about development of the video game.

### DETAILED DESCRIPTION OF THE INVENTION

One embodiment of the present invention is applicable to a gaming environment where game code is executed on a computer system to enable a player to interact with a system and play a video game. Prior to discussing the specifics of the present invention, it may be helpful to discuss some of the gaming environments in which an illustrative embodiment of the present invention may be employed.

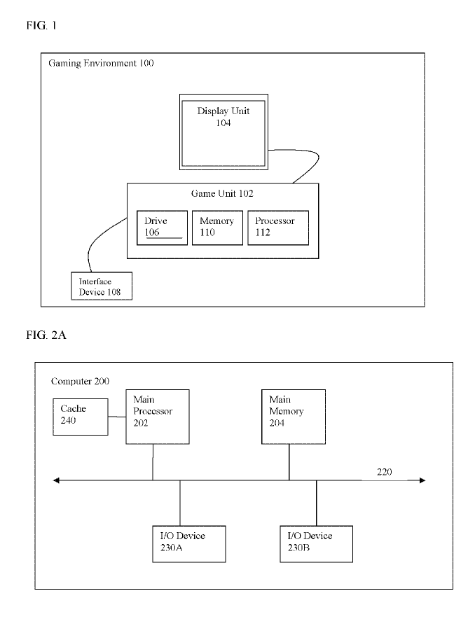

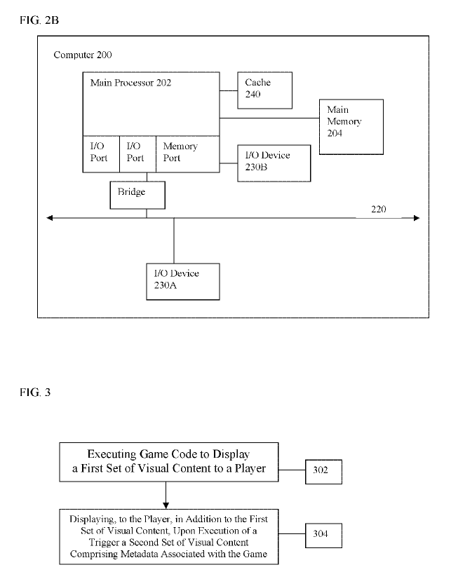

FIG. 1 depicts a block diagram of one embodiment of a gaming environment 100 in which the present invention may be employed, including a game unit 102, a display unit 104, a drive 106, an interface device 108, memory 110, and a processor 112. The game unit 102 comprises the drive 106 and is connected to the display unit 104 and to the interface device 108. In one embodiment, the game unit 102 comprises a personal computer system. FIG. 2A and FIG. 2B depict block diagrams of a typical computer 200 useful in an embodiment of the present invention in which the game unit 102 comprises a computer system. In many embodiments, the game unit 102 is provided as a personal computer or computer server, of the sort manufactured by the Hewlett-Packard Corporation of Palo Alto, Calif. or the Dell Corporation of Round Rock, Tex. As shown in FIG. 2A and FIG. 2B, each computer 200 includes a central processing unit 202, and a main memory unit 204. Each computer 200 may also include other optional elements, such as one or more input/output devices 230a-230n (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS6411, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athlon 64 FX, the AMD Athlon, or the AMD Duron processor, manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B, the main memory 204 may be DRDRAM.

FIG. 2A and FIG. 2B depict embodiments in which the main processor 102 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 202 may use an Advanced Graphics Port (AGP) to communicate with the display. FIG. 2B depicts an embodiment of a computer 200 in which the main processor 202 communicates directly with I/O device 230b via HyperTransport, Rapid I/O, or Infiniband. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer 100. Input devices include keyboards, mice, trackpads, trackballs, microphones, and drawing tablets. Output devices include video displays, speakers, inkjet printers, laser printers, and dye-sublimation printers.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIG. 2A and FIG. 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

A computer 200 may also be any personal computer (e.g., 286-based, 386-based, 486-based, Pentium-based, Pentium II-based, Pentium III-based, Pentium 4-based, Pentium M-based, or Macintosh computer), Windows-based terminal, Network Computer, wireless device, information appliance, RISC Power PC, X-device, workstation, mini computer, main frame computer, personal digital assistant, or other computing device. Windows-oriented platforms supported by the server can include, without limitation, WINDOWS 3.x, WINDOWS 95, WINDOWS 98, WINDOWS NT 3.51, WINDOWS NT 4.0, WINDOWS 2000, WINDOWS CE, WINDOWS ME, WINDOWS XP, WINDOWS Longhorn, MAC/OS, Java, and UNIX. The server can include a visual display device (e.g., a computer monitor), a data entry device (e.g., a keyboard), persistent or volatile storage (e.g., computer memory) for storing downloaded application programs, a processor, and a mouse. Execution of a communication program allows the server to participate in a distributed computer system model.

The game unit 102 may also comprise a game console. Typical gaming devices include, but are not limited to, the Microsoft® Xbox® device, manufactured by Microsoft Corporation of Redmond, Wash., and the PlayStation, PlayStation 2 and PlayStation Portable family of devices, each developed, marketed and distributed in the North American Market by Sony Computer Entertainment America Inc. of Foster City, Calif., a wholly owned subsidiary of Sony Corporation of Japan, Inc. The game unit 102 may also comprise a portable gaming device such as the Gameboy Advance and GameCube family of devices, manufactured by Nintendo of Japan or the N-Gage, manufactured by Nokia Corporation of Finland. A typical game console or gaming device may comprise many of the elements described in FIG. 2A and 2B, including the processor 202 and the main memory 204.

For embodiments in which the game unit 102 is a mobile device, the device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; or the i300 or i330, manufactured by Samsung Electronics Co., Ltd., of Seoul, Korea. A typical mobile device may comprise many of the elements described in FIG. 2A and 2B, including the processor 202 and the main memory 204.

In other embodiments in which the game unit 102 is mobile, it may be a personal digital assistant (PDA) operating under control of the PalmOS operating system, such as the Tungsten W, the VII, the VIIx, the i705, all of which are manufactured by palmOne, Inc. of Milpitas, Calif. In further embodiments, the game unit 102 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, Calif.; or the Toshiba PocketPC e405, manufactured by Toshiba America, Inc. of New York, N.Y. In still other embodiments, the game unit 102 is a combination PDA/telephone device such as the Treo 180, Treo 270, Treo 600, or the Treo 650, all of which are manufactured by palmOne, Inc. of Milpitas, Calif. In still further embodiments, the game unit 102 is a cellular telephone that operates under control of the PocketPC operating system, such as the MPx200, manufactured by Motorola Corp. A typical combination PDA/telephone device may comprise many of the elements described in FIG. 2A and 2B, including the processor 202 and the main memory 204.

In one embodiment, the memory 110 may store the game code and a plurality of sets of content. The user may install the game code in the system memory 110. The game unit 102 may comprise a drive 106 through which a user may install game code. In some embodiments, the drive 106 comprises a DVD-drive. In other embodiments, the drive 106 comprises a CD-ROM drive.

In some embodiments, the user may install game code onto the game unit 102 by inserting a physical disk into the drive 106 and transferring game code from the disk onto the memory 110. In other embodiments, the user may install game code onto the game unit 102 by connecting to a network and downloading the game code onto the memory 110. In one of these embodiments, the user connects the game unit 102 to a computer network and downloads the game code onto the memory 110. In another of these embodiments, the user connects the game unit 102 to a cellular network and downloads the game code onto the memory 110.

In one embodiment, the interface device 108 allows the user to provide input to the game unit 102. The interface device 108 may comprise a keyboard, a mouse, a trackball, a microphone, a joystick, a gamepad, a camera-based peripheral input device, a steering wheel, a dance pad, a drum pad, a musical controller or a game controller. In some embodiments, the interface device 108 is built into the game unit 102. In other embodiments, the interface device 108 connects wirelessly to the game unit 102.

The display unit 104 may comprise a visual display device (e.g., a computer monitor). In some embodiments, the display unit 104 comprises a cathode ray tube display. In other embodiments, the display unit 104 comprises a liquid crystal display. In some embodiments, the game unit 102 comprises specialized hardware to enhance the quality of the display. In these embodiments, the game unit 102 may comprise hardware acceleration or graphics cards.

In one embodiment, the game unit 102 executes game code installed onto it by the user. In one embodiment, the processor executes the game code to display to a player a first set of content and, in addition to the first set of content, upon execution of a trigger, a second set of content, the second set of content comprising metadata associated with the game code. The processor 112 may be in communication with the memory 110.

Execution of game code may comprise displaying on the display unit 104 the output of the game code. In one embodiment, game code output includes a graphical user interface with which the user may interact to play a game. The graphical user interface may depict a character the user controls to play the game. The user may send input to the game unit 102 with the interface device 108 to control characters and manipulate the graphical user interface.

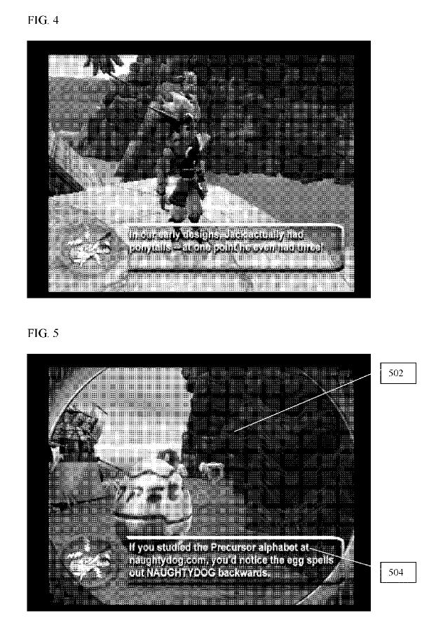

Referring now to FIG. 3, a flow diagram depicts one embodiment of the steps taken in a method of enhancing a playing experience of a player of a video game. In brief overview, game code is executed to display a first set of content to a player (step 302). In addition to the first set of content, a second set of content is displayed to the player upon execution of a trigger, the second set of content comprising metadata associated with the game code (step 304).

Referring now to FIG. 3, and in greater detail, game code is executed to display a first set of content to a player (step 302). In one embodiment, the game code comprises a video game. In another embodiment, the game code comprises a computer game. In some embodiments, displaying the first set of content enables presentation of a gaming environment to the player. In one embodiment, the first set of content comprises a set of images with which the player interacts to play a video game.

In some embodiments, executing the game code on the game unit 102 enables a user to play a video game. Types of video games include, without limitation, sports action games, martial arts fighting games, fantasy games, music rhythm games, sniper games, role playing games, massively multi-player online role playing games, arcade style games, strategy games, simulation games, platformer games, first person shooter games, third person shooter games, puzzle games, adventure games, fighting games, racing games, or vehicle combat games.

In addition to the first set of content, a second set of content is displayed to the player upon execution of a trigger, the second set of content comprising metadata associated with the game code (step 304).

In one embodiment, the second set of content comprises visual content. In another embodiment, the second set of content comprises audible content. In still another embodiment, the second set of content comprises tactile content. In some embodiments, the second set of content comprises a combination of perceptible content. In one of these embodiments, the second set of content may comprise a tactile rumbling of an interface device followed by a presentation of audible or visual content.

In one embodiment, the second set of content comprises a text box containing metadata. In some embodiments, the second set of content is superimposed on the first set of content. Referring ahead to FIG. 4, a screen shot depicts one embodiment of a second set of content displayed to the player in addition to the first set of content.

In one embodiment, execution of a trigger comprises execution of game code. In some embodiments, the player executes the trigger. In one of these embodiments, the player executes the trigger by selecting an element in a graphical user interface. In another of these embodiments, the trigger may comprise an element within a gaming environment. In this embodiment, the player may execute the trigger by interacting with the element within the gaming environment. In still another of these embodiments, the player executes the trigger by completing a level of interaction with the first set of content.

In one embodiment, the execution of game code is paused during the display of the second set of content. In this embodiment, the player may choose to review the second set of content without the review having an impact on the performance of the player in the game. In some embodiments, execution of game code continues after a predetermined amount of time.

In one embodiment, display of the second set of content is continuous. In this embodiment, the second set of content may have a ticker tape or marquee effect. In another embodiment, display of the second set of content is stopped after a predetermined time. In this embodiment, display of the second set of content ceases after the predetermined time. This may enable the player to continue to focus on game play after reviewing the second set of content. This embodiment may minimize distraction.

Referring now to FIG. 5, a screen shot depicts one embodiment in which a second set of content comprises facts about the video game. In FIG. 5, the first set of content 502 depicts a scene in the video game in which the character encounters a large floating egg with illegible text inscribed on the eggshell. The second set of content 504 contains a fact about the video game, in this embodiment, that the text on the eggshell can be translated into English using an alphabet posted on the game website. In some embodiments, facts about the video game include information about the history of the video game. In one of these embodiments, facts about the history of the game may include release dates, ratings, or statistics.

In some embodiments, facts about the video game include suggestions to the player. Referring now to FIG. 6, a screen shot depicts one embodiment in which the second set of content 604 provides the user with a suggestion relating to game play. In this embodiment, the first set of content 602 displays the character losing life after jumping off a high cliff. The second set of content 604 indicates to the user that when jumping off a high cliff, pressing “O” just before hitting the ground can prevent the character from losing life.

In some embodiments, the metadata is associated with an Easter egg. In other embodiments, the metadata is associated with a cheat code. In one of these embodiments, the metadata may contain information regarding how to use the Easter egg or cheat code. In another of these embodiments, the metadata may explain why developers placed the Easter egg or cheat code where they did.

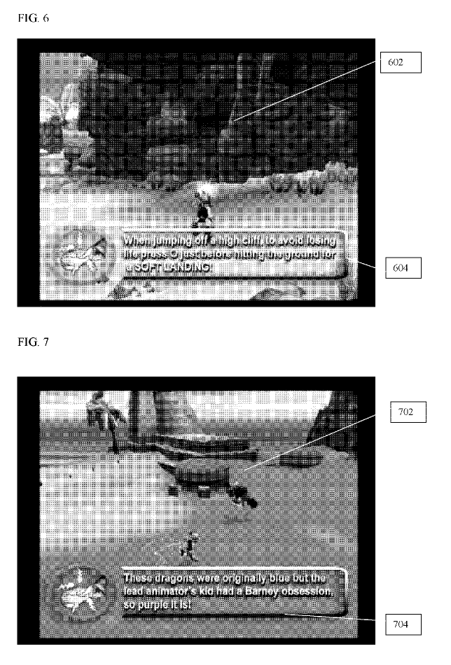

In some embodiments, the metadata comprises information about a video game developer. In one embodiment, the metadata comprises personal information about the video game developer. In another embodiment, the metadata comprises explanations of decisions the game developers made in developing an element of the video game. Referring now to FIG. 7, a screen shot depicts an embodiment of a second set of content comprising information about a video game developer. In this embodiment, the first set of content 702 depicts the character interacting with a purple dragon. The second set of content 704 explains why the lead animator changed the color of the dragon from the original blue to purple.

In one embodiment, the metadata comprises facts about design of the video game. In some embodiments, facts about design of the video game include explanations about the reasons designers had for including a particular element in the video game. In other embodiments, facts about design of the video game include influences on the design. Referring now to FIG. 8, a screen shot depicts one embodiment of a second set of content comprising information describing an influence on the design. The first set of content 802 depicts a graphical representation of the main character entering a village. The second set of content 804 informs the user that the inspiration for the village came from a French comic book.

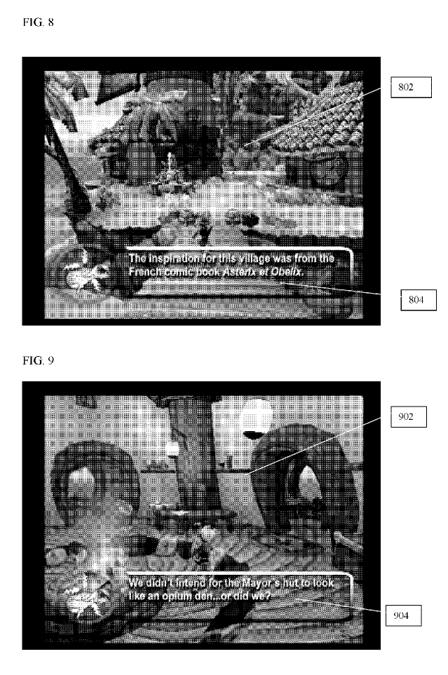

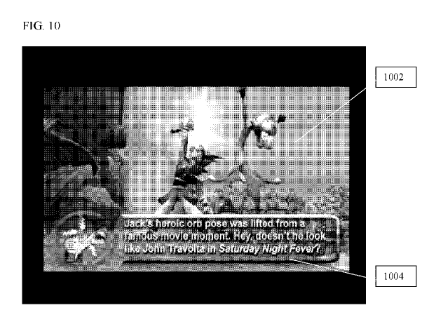

In one embodiment, the metadata comprises facts about development of the video game. In some embodiments, the metadata comprises facts about how the video game was developed. In other embodiments, the metadata comprises facts about why an element in the video game developed in a particular manner. Referring now to FIG. 9, a screen shot depicts one embodiment of a second set of content comprising information about development of the video game. In this embodiment, the first set of content 902 depicts the character in a large room. The second set of content 904 indicates to the user that this room is the Mayor's den and the room was developed to portray a particular look, in this case, that of an opium den.

Referring now to FIG. 10, a screen shot depicts a second embodiment of a second set of content comprising information about development of the video game. In this embodiment, the first set of content 1002 depicts the character having just achieved an objective of the game. The second set of content 1004 informs the user that the character's stance was intended to remind viewers of a famous movie moment.

The present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the invention has been shown and described with reference to specific preferred embodiments, it should be understood by those skilled in the art that various changes in form and detail may be made therein without departing from the spirit and scope of the invention as defined by the following claims.

What is claimed as new and desired to be protected by Letters Patent of the United States is:

1. A method of enhancing a playing experience of a player of a video game, the method comprising:
(a)executing game code to display a first set of content to a player; and
(b) displaying, to the player, in addition to the first set of content, upon execution of a trigger, a second set of content, the second set of content comprising metadata associated with the game code.

2. The method of claim 1, wherein the metadata comprises facts about the video game.

3. The method of claim 1, wherein the metadata is associated with an Easter egg.

4. The method of claim 1, wherein the metadata is associated with a cheat code.

5. The method of claim 1, wherein the metadata comprises facts about development of the video game.

6. The method of claim 1, wherein the metadata comprises facts about design of the video game.

7. The method of claim 1, wherein the metadata comprises information about a video game developer.

8. The method of claim 1, further comprising pausing the executing of game code during the display of the second set of content.

9. The method of claim 1, further comprising removing the second set of content after a predetermined time.

10. An apparatus for enhancing a playing experience of a player of a video game, comprising:
system memory storing game code and a plurality of sets of content; and
a processor of a system, in communication with the system memory, the processor executing the game code to display to a player a first set of content and, in addition to the first set of content, upon execution of a trigger, a second set of content, the second set of content comprising metadata associated with the game code.

11. The apparatus of claim 10, wherein a user stores the game code in the system memory.

12. The apparatus of claim 10, wherein the processor of the system displays the second set of content upon execution of an instruction in the game code.
